(19) United States
(12) Patent Application Publication
(10) Pub. No.: US 2015/0294777 A1
(43) Pub. Date: Oct. 15, 2015

(54) Induction Component

(71) Applicant: Würth Elektronik iBE GmbH, Thyrnau (DE)

(72) Inventors: Klaus Mayerhofer, Freyung (DE); Christian Aloy, Aicha vorm Wald (DE)

(21) Appl. No.: 14/581,380

(22) Filed: Dec. 23, 2014

(30) Foreign Application Priority Data
Apr. 14, 2014 (DE) 102014207140.2

(51) Int. Cl. H01F 27/04; H01F 27/29

(52) U.S. Cl. CPC H01F 27/04; H01F 27/292

(57) ABSTRACT

An induction component includes a housing of ferrite material, a coil and a carrier element for the coil. The carrier element for the coil forms a holder for the same. The coil is connected to the carrier element and the winding ends of the coil are soldered to connection realizations of the carrier element. The carrier element is inserted with the coil into the housing and the connection contacts present on the carrier element serve for connecting the induction components to a printed circuit board.

### TECHNICAL FIELD

The invention relates to an induction component, in particular a high current inductor. These types of components include in a housing a coil, the winding ends of which are to be connected to solder pads of a printed circuit board. In the simplest case, the tin-plated winding ends are realized as surface mounted device (“SMD”) solder faces.

### DESCRIPTION OF THE BACKGROUND ART

In the case of loose wire ends, however, the problem is that they do not always extend precisely in one plane, which is necessary for SMD assembly.

It is already known to bend the winding ends of a coil that is formed from flat wire around the bottom of a housing such that the ends of the windings lie in one plane and can serve as a connection contact (U.S. Pat. No. 6,922,130 B2).

It is also known to attach contact elements on a bottom of a housing and to connect the winding ends, which are provided in each case with a hole, of the coil, which is formed from flat wire, to said contact elements in a positive locking manner (US 2013/0194061 A1).

In addition, it is known to arrange a rectangular plate, which comprises angled contact elements on its end faces that are located opposite one another, in a housing which is made up of two parts and to connect the coil ends to the angled contact elements via conductor paths of said plate (JPH 07-320961 A).

### SUMMARY OF THE INVENTION

The object underlying the invention is to create an induction component which is particularly suitable for automatic assembly.

To achieve said object, the invention proposes an induction component with the features named in claim 1 Further developments of the invention are the object of the sub-claims.

The induction component which is proposed by the invention therefore includes a housing, in particular produced from ferrite material or from a pressed substrate powder, in which at least one coil is arranged. The coil is carried by a carrier element which is also arranged in the housing. The carrier element includes connection contacts on the one side in order to connect the induction component to a printed circuit board in a mechanical and operational manner and on the other side connection realizations to which the winding ends of the coil are attached and to which they are joined.

The planarity of the connection contacts therefore no longer depends on the form and nature of the winding ends of the coil and the winding ends of the coil can be joined to the connection realizations reliably and in a process-safe manner. For example, the connection realizations are formed as solder plates to which the winding ends are soldered.

In a further development of the invention it can be provided that the carrier element consists of plastics material and the connection contacts are injected or pressed into the plastics material. This simplifies the production.

In yet another further development of the invention, it can be provided that the connection realization for connecting each winding end is realized integrally with the respectively associated connection contact. Consequently, no additional connections are necessary between the winding ends and the metal parts which form or comprise the connection contacts. Said metal parts can be coated on their side forming the connection contact, depending on the requirements of the individual case. Connection realizations and connection contacts can then be injected in portions into the plastics material of the carrier part.

In another further development of the invention, it can be provided that the carrier element is secured in a non-displaceable manner in the housing. This can be effected preferably as a result of positive locking between the carrier element and the housing, it additionally being possible for bonding to be provided where applicable.

In a further development of the invention, it can be provided that the carrier element is centered in the housing by the housing. For example, the housing comprises a cylindrical coil core and the carrier element is centered on the coil core by way of a tubular portion.

It can also be provided that the carrier element comprises a centering means for the core. Said centering means makes it possible for the carrier element at the same time to form an assembly aid for assembly when assembling the induction component. In an advantageous manner, the centering means for the coil is realized as a tubular portion of the carrier element. The coil is centered by way of the outside circumference of the tubular portion and the carrier element is centered on the housing by way of the inside circumference of the tubular portion.

It can be provided in a further development that the housing comprises a level bottom surface and a level top surface which extends parallel to said bottom surface, even the end faces on the short end sides being able to be realized as level faces. The bottom surface is to be understood as that side of the housing which lies opposite the printed circuit board when being attached to a printed circuit board.

In a further development, the coil of the induction components proposed by the invention can be wound from flat wire, the flat side of which extends perpendicular to the coil axis.

To improve the assembly and the stability of the fastening further, the carrier element can comprise a third face which is constructed as a contact face such that it can be attached to the printed circuit board using the same technology by means of which the connection contacts are connected to the printed circuit board. Said third connection face, however, does not form any contact as it is not conductively connected to a coil. In place of a third face, several such faces can also be provided in order to ensure secure fastening on the printed circuit board. As an alternative to this, the third face or further faces can also consist of plastics material, for example at the end of a plastics material pin or plastics material stud which is then pressed or hot-staked to the printed circuit board.

Said solution applies first and foremost to an induction component with only one coil.

It has already been mentioned that the carrier element also serves for centering and holding the coil. For this purpose, the carrier element can comprise a central ring portion or tubular portion which serves both for centering the carrier element in relation to the housing and for centering the carrier element in relation to the coil or vice versa.

Said central ring portion can be realized in a plate-shaped manner, that is lying substantially in one plane Both its outside edge and its inside edge can serve for centering purposes in relation to the housing.

For centering the coil, individual fingers which extend perpendicular to the plane of the ring portion can be attached on the inside edge of the ring portion.

The central ring portion can, however, also be cylindrical. The cylinder shape of the ring portion can serve both for securing the carrier element and for centering the coil.

In a further development of the invention, the carrier element can comprise at least one leg which reaches up to the bottom surface of the housing of the induction component and is provided there with a foot. The bottom surface of the foot preferably lies approximately in the plane of the bottom surface of the housing.

The connection contact can emerge in the bottom surface of the foot and it then also lies in one plane such that it is particularly suitable for SMD contacting with the printed circuit board.

It can be provided in a further development that for connecting the winding ends of the coil the connection realization projects at right angles out of a face, preferably out of the top surface of the foot of the carrier element. As a result, a face is available for the joint between the winding ends and the connection realization, which face enables free access for the assembly and for the production of the joint, for example for a soldered joint. The connection realization can also comprise, for example, a metal sheet that is bent in a U-shaped manner, the winding end being pushed between the legs of the metal sheet and then connected to the same.

### BRIEF DESCRIPTION OF THE DRAWINGS

Further features, details and preferences of the invention are produced from the claims and the abstract, the wording of both of which being made as a result of reference to the content of the description, from the following description of preferred embodiments of the invention as well as by way of the drawing. Individual features of the different embodiments can be combined in this case in an arbitrary manner without exceeding the framework of the invention. The drawings are as follows:

FIG. 1 shows an isometric view from obliquely above of an induction component according to a first embodiment of the invention;

FIG. 2 shows an exploded representation of the induction component of FIG. 1:

FIG. 3 shows a view obliquely from below of the carrier element of the induction component of FIGS. 1 and 2;

FIGS. 4a-d show several steps of the assembling of an induction component according to the invention according to a further embodiment of the invention;

FIGS. 5a-d show several steps of the assembling of an induction component according to a further embodiment of the invention;

FIG. 6 shows a side view of one housing half of an induction component according to a further embodiment of the invention;

FIG. 7 shows a top view from above of the housing half of FIG. 6;

FIG. 8 shows a top view of a coil for an induction component according to the invention;

FIG. 9 shows a side view of the coil from FIG. 8;

FIG. 10 shows a side view of the finished induction component with two housing halves according to FIG. 6 and a coil according to FIG. 8;

FIG. 11 shows a view of the induction component of FIG. 10 from a direction offset by 90′;

FIG. 12 shows the view from below of the induction component of FIG. 10:

FIG. 13 shows the view from above of the induction component of FIG. 10;

FIG. 14 shows the view from below of a carrier element of the induction component of FIG. 10;

FIG. 15 shows the view from above of the carrier element of FIG. 14;

FIG. 16 shows the view from the side of the carrier element of FIG. 14;

FIG. 17 shows the front view of the carrier element of FIG. 14;

FIG. 18 shows the view from below of a carrier element of a further embodiment of the invention;

FIG. 19 shows the view from above of the carrier element of FIG. 18;

FIG. 20 shows the view from the side of the carrier element of FIG. 18;

FIG. 21 shows the front view of the carrier element of FIG. 18;

FIG. 22 shows a perspective view of an induction component proposed by the invention.

### DETAILED DESCRIPTION

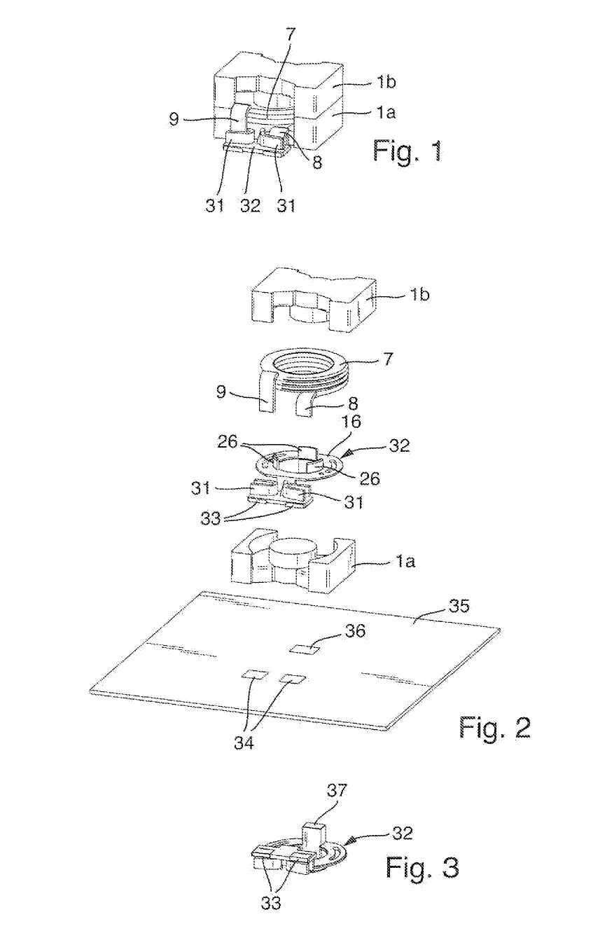

FIG. 1 shows a perspective view from obliquely above of an induction component according to the invention according to a first embodiment. The induction component comprises a bottom housing half is and a top housing half lb which are realized identically to one another. A coil 7 is arranged inside the housing. The coil is wound from flat material and comprises winding ends 8, 9 which are bent at right angles in relation to the actual winding of the coil. The winding ends 8, 9 are arranged inside connection realizations 31, which are in each case U-shaped, and are soldered with said connection realizations 31. The connection realizations are arranged on a carrier part 32 which also holds the coil 7, as is explained again below.

The representation in FIG. 2 shows an exploded representation of the induction component of FIG. 1. The coil 7 with the winding ends 8, 9 is placed onto the carrier part 32 and is held on a ring portion 16 of the carrier part 32 by means of three webs 26 which are arranged on the circumference of a central hole of the ring component 16 and follow the curvature of the hole. As a result, the webs 26 define portions of a cylindrical surface which is matched to the inside diameter of the coil 7 and, as a result, centers the coil 7 on the carrier part 32. The U-shaped realization of the connection portions 31 can be seen in the exploded representation, the winding ends 8, 9 being pushed into the respective interior of the U-shaped connection portions 31. The winding ends 8, 9 can then be soldered to the connection portions 31. If the coil 7 is connected to the carrier element 32 in this manner, the carrier element 32 is then inserted into the bottom housing half 1a. The top housing half 1b can then also be placed in position and the two housing halves can be connected, for example bonded, together.

Connection contacts 33, which are connected to the connection realizations 31 so as to be electrically conducting, are provided on a bottom surface of the carrier element and, in particular, one connection face 33 and one connection realization 31 in each case consist of an integral, bent metal sheet. During the production of the carrier part 32 from plastics material, said bent metal sheets are injected into said carrier part. This ensures that the connection contacts 33 lie in one common plane. As a result, it is easily possible to connect the induction component to solder pads 34 on a printed circuit board 35 by means of the connection contacts 33.

In the representation in FIG. 2, the printed circuit board 35 comprises a third solder pad 36. Said solder pad 36 is provided for the purpose of being connected, for example soldered, to the bottom surface of a leg 37 of the carrier element 32, see FIG. 3. In this way, the induction component can be soldered reliably to the printed circuit board 35 at three points. The solder pad 36, however, is preferably isolated and non-operative from an electrical viewpoint. As the leg 37 is also injected when the carrier element 32 is produced and includes on its bottom surface, for example, an injected, metal face, it can be ensured when the carrier element 32 is produced that the connection contacts 33 and the bottom surface of the leg 37 lie precisely in one plane and the induction component according to the invention is consequently able to be soldered reliably to the printed circuit board 35.

The representation in FIG. 3 shows a view from below of the carrier element 32.

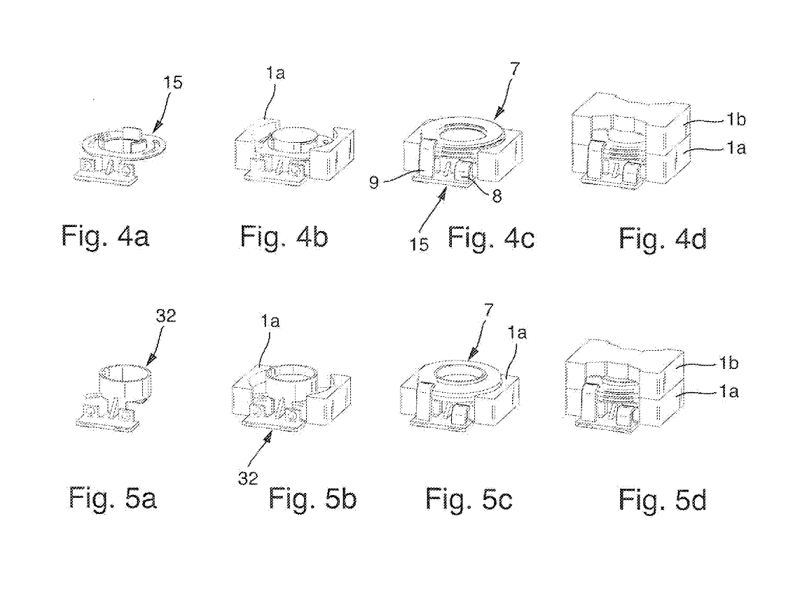

The representation in FIGS. 4a-d show several steps when assembling an induction component according to the invention according to a further embodiment, A carrier 15 is shown in FIG. 4a, said carrier being explained in more detail again by way of FIGS. 14 to 17. Said carrier 15 is inserted into the bottom housing half 1a, as shown in FIG. 4b. In the next step, as shown in FIG. 4c, the coil 7 is placed onto the carrier element 15 and the coil ends 8, 9 are soldered to the connection realizations on the carrier element 15. In the last step, as shown in FIG. 4d, the top housing half 1b is placed onto the bottom housing half 1a and the two housing halves are connected, for example bonded, together. Deviating from the steps shown in FIGS. 4a-d, the coil 7 can first of all be connected to the carrier element 15 and the unit produced by the carrier element 15 and the coil 7 is then inserted into the bottom housing half 1a.

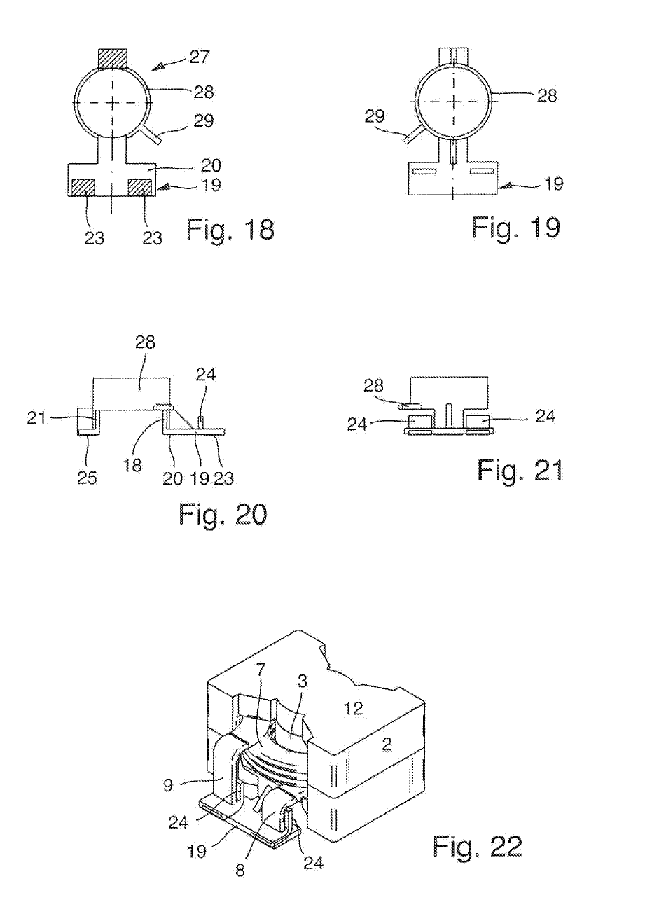

The representation in FIGS. 5a-d show various steps when assembling an induction component according to the invention according to a further embodiment. In this case, a carrier element 32, as shown in FIG. 5a, is developed differently to the carrier element 15 and will be explained in more detail again below by way of FIGS. 18 to 21. For the rest, however, as shown in FIGS. 5b-d, the assembly is effected as indicated in FIGS. 4b-d and once again the coil 7 can first of all be connected to the carrier element 32 and only then inserted into the bottom housing half 1a.

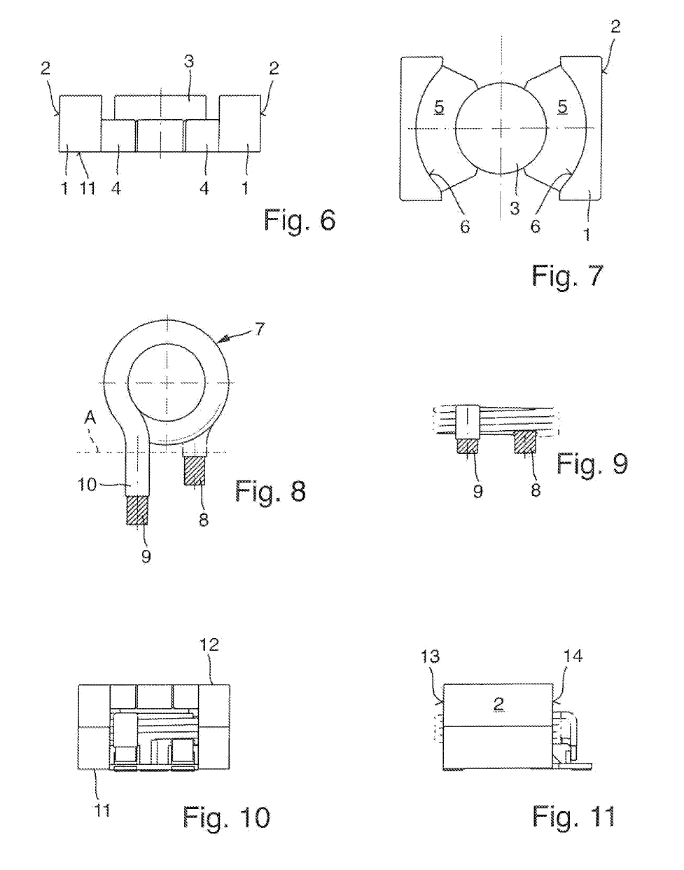

FIG. 6 shows one half of a housing of an induction component proposed by the invention. Said half is shown as the bottom half. The top half is identical, but is arranged in a precisely reversed manner and is placed onto the bottom half shown. The housing half comprises two wings 1 which are shown on the left-hand side and on the right-hand side and in each case comprise a level outer boundary face 2. A central core 3 which comprises a circular cylindrical shape is shown in the center of the housing half. Bottom portions 4 can be seen between the two wings 1. Said bottom portions 4 in each case form a level supporting surface 5 which lies between the core 3 and the wings 1 and which can be seen more clearly in FIG. 2. The supporting surfaces 5 are provided for a coil which is not shown in FIG. 6.

The two housing halves, in this case, do not necessarily have to be realized in an identical manner. For example, one housing half can be realized in the shape of a plate and the other housing half can be realized in an approximately E-like manner.

As can be seen in FIG. 2, boundary faces 6, which face one another, of the two wings 1 are realized in a concentric manner with respect to the core 3 and lie in each case on a circular cylindrical outer surface. As a result, a ring channel, which is defined downward by the supporting surfaces 5 of the bottom portions 4, is formed on the bottom portions 4, whilst it is defined inside and outside by the respective wall portions 6 of the two wings 1 or the outside surface of the core 3.

When viewed from above, see FIG. 7 at the top or bottom, the housing half is provided with indentations such that the supporting surfaces 5, therefore, do not extend over the entire extent of the core 3 but in each case cover approximately 90° on both sides.

The ring channel already mentioned serves for receiving a coil 7 which is shown in FIGS. 8 and 9. The coil 7 is a multilayer coil, the individual windings of which are wound around a central circular opening. The coil 7 comprises two winding ends 8, 9 which, in the representation in FIG. 8, still lie in the respective plane of the individual winding. The insulation 10 of the winding is removed at both the winding ends 8, 9. The top winding end 9 projects somewhat further out than the bottom winding end 8. The two winding ends are bent downward at right angles about the line A in relation to the drawing plane of FIG. 8 such that in the representation in FIG. 9 they can be seen in front view. As a result of the top winding end 9 being somewhat longer than the bottom winding end 8, the two winding ends end in the bent state in FIG. 9 in the identical plane.

The coil 7 is inserted into the ring channel between the core 3 and the faces 6 of the bottom housing half by means of a carrier element which is yet to be described. and a second housing half, as already mentioned, is placed in the reverse position onto the bottom half. A shape of the housing as is shown in FIGS. 10 to 13 is produced as a result.

It has already been seen from FIG. 6 that the bottom surface 11 of the housing lies in one plane. From the side view in FIG. 10 which is shown from the same direction it can be seen that the top surface 12 of the housing also lies in one plane which extends parallel to the bottom surface 11 of the housing. FIG. 11 shows the housing from a direction from the left in FIG. 10. It can be seen from this that the rear side 13 and the front side 14 of the housing, with the exception of the indents to be seen in FIG. 7, each also lie equally in one plane, said planes extending parallel to one another. The housing therefore comprises, with the exception of the indents, an approximately cuboid shape. The coil windings protrude slightly in relation to the front side 14 and the rear side 13 of the housing.

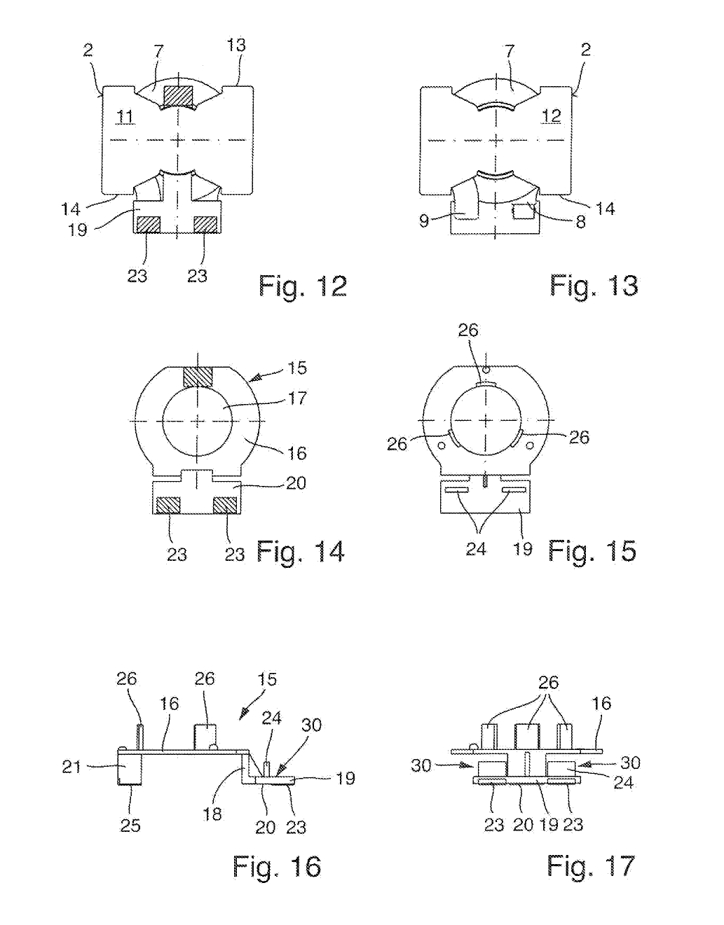

FIG. 12 shows the induction component from below and FIG. 13 shows the induction component from above. Other details to be seen in FIGS. 12 and 13 will be elaborated on again below. A perspective view of the induction component is shown in FIG. 22.

The carrier element already mentioned is shown in FIGS. 14 to 17 according to a first embodiment. The carrier element 15 includes a ring portion 16 which surrounds a central circular hole 17. The diameter of said hole 17 corresponds to the outside diameter of the core 3 of the housing. The outside contour of the ring portion 16 also corresponds over the majority of the circumference to a circle, the diameter of which corresponds to the spacing between the inside faces 6 of the wings 1 of the housing. The carrier element 15 includes devices on the two flattened sides of the ring portion 16, which are located opposite one another, in order to connect the carrier element to a printed circuit board.

To this end, reference is now made to FIG. 16 which shows the carrier element 15 from the side. The ring portion 16, in the case of said embodiment, comprises the form of a plate. On the one side of the ring portion 16, which is associated with the front side 14 of the housing, the carrier element comprises a leg 18 which is angled downward at right angles in relation to the plane of the ring element 16. At its end, the leg 18 comprises a foot 19, the bottom surface 20 of which lies in a plane parallel to the plane of the ring element 16.

On the oppositely situated side of the ring portion 16, which is associated with the rear side 13 of the housing, the carrier element 15 also comprises a leg 21, the bottom surface 22 of which lies in the same plane as the bottom surface 20 of the foot 19. Two metal angled elements 30, the horizontal bottom limbs of which protrude slightly in relation to the bottom surface 20 of the foot 19 and there form in each case a connection contact 23, are injected into the foot 19 of the carrier element 15 which is sprayed integrally from plastics material. Said connection contacts 23 are shown in FIG. 14 and can also be seen in FIG. 12 which shows the housing from below.

The second, upwardly directed limbs of the angled elements 30 project upward at right angles in relation to the top surface of the foot 19 and there form a connection realization 24 in each case for one winding end 8, 9 of the coil 7.

A metal level element 25, which does not, however, form any connection realization for a winding end, is also injected or pressed into the bottom surface of the rear leg 21. As the induction component is to be soldered to solder pads of a printed circuit board, the rear leg 21 forms not only an alignment aid but also a fastening possibility as the metal element 25 can also be soldered with a non-operating solder pad at this point.

Three fingers 26, which follow the curvature of the edge of the hole 17, are integrally formed on the top surface of the ring element 16, see FIG. 15, directly on the edge of the hole 17. The carrier element 15 serves for mounting and fastening the coil 7 before the same is inserted into the housing. The three fingers 26 hold the coil 7 such that the angled winding ends 8, 9 of the coil 7 abut directly against the connection realizations 24 and are able to be soldered there to said connection realizations, The unit formed as a result from the carrier element 15 and the coil 7 can then be inserted into the housing and bonded to said housing The coil is arranged in a positive locking manner with the carrier element 15 in the housing even without the bonding. The connection contacts 23 on the bottom surface of the feet 19, 21 of the carrier element 15 then serve for connection to the solder pads of a printed circuit plate. In the case of the embodiment of the carrier element 15 shown in FIGS. 14 to 17, the three fingers 26 serve for centering purposes and the ring element 16 for supporting the coil 7.

Following FIGS. 18 to 21 show a second embodiment of a carrier element 27. Said carrier element 27 once again includes a central ring element 28 which is now realized as a short tubular sleeve. The inside diameter of the ring element 28 corresponds to the outside diameter of the core 3. A leg 18, which merges into a foot 19 which is realized in the same manner as the foot 19 in the case of the preceding embodiment, is once again integrally formed on the bottom surface of the ring element 28, see FIG. 20. The connection realization 24 projects upward at right angles from the top surface of the foot 19 and the connection contact 23 emerges on the bottom surface of the foot 19.

A second leg 21, which in the case of said embodiment is realized as an angle bracket and comprises a metal face 25 on its bottom surface, is integrally formed on the rear side of the carrier element 27, on the left in FIG. 20. Said metal face 25 has the same function as in the case of the preceding embodiment, it therefore serves for fastening on the printed circuit board.

The ring element 18 serves for centering the coil 7, the inside diameter of which is slightly greater than the outside diameter of the core 3 of the housing such that it is able to be pushed onto the ring portion 28. A web 29, which is integrally formed on the bottom surface of the ring portion 28 and projects radially outward, serves for securing the position of the coil 7 in, the axial direction. The coil 7 sits on this web 29.

For assembling an induction component according to the invention, the coil 7 and the carrier element 15 or 27 are first of all produced. The winding ends 8, 9 of the coil are stripped of their insulation and angled in the manner shown in FIG. 9. The coil 7 is then placed onto the carrier element 15 or 27 and the winding ends 8, 9 are soldered to the connection realizations 24. After this, the unit formed in each case of the coil and the carrier element 15 or 27 is inserted into the bottom housing half in which said unit is secured in a positive locking manner. The second, top housing half can then be placed onto the bottom housing half and connected to said bottom housing half. An induction component which is suitable for connection to a printed circuit board using SMT technology is consequently created. The connection contacts 23 and the metal element 25 lie in a defined plane which is defined when the carrier element is produced.

The result, namely a finished induction part, is shown once again in a perspective view in FIG. 17.

In the example shown, the winding ends 8, 9 of the coil 7 are soldered to the front faces of the connection realizations 24. It is also conceivable for them to be soldered to the rear faces of the connection realizations. It is also possible to realize the connection realizations in a U-shaped manner such that the winding ends 8, 9 rest between the two limbs of the U, see FIGS. 1 to 3.

1. Induction component, in particular high current inductor, having
a housing that forms the core of the induction component,
at least one coil (7) which is arranged in the housing,
a carrier element (15, 27, 32) for the coil (7) which is arranged in the housing and comprises
connection contacts (23) which are accessible from an outside surface of the housing for connecting the coil (7) to a printed circuit board and
connection realizations (24) for connecting the winding ends (8, 9) of the coil (7), to which
the winding ends are joined, in particular soldered.

2. Induction component according to claim 1, characterized in that the connection contacts (23) are located at least in portions on a bottom side of the carrier element (15, 27, 32).

3. Induction component according to claim 2, characterized in that the connection contacts project to a minor extent in relation to the bottom side of the carrier element (15, 27, 32).

4. Induction component according to claim 2, characterized in that the connection contacts (23) at least in portions are accessible from one side of the carrier element (15, 27, 32).

5. Induction component according to claim 2, wherein the carrier element (15, 27) is made of plastics material and the connection contacts (23) are injected or pressed into the plastics material.

6. Induction component according to claim 2, wherein the connection realization (24) for connecting each winding end (8, 9) is realized integrally with the respective connection contact (23).

7. Induction component according claim 2, wherein the carrier element (15, 27) is secured in a non-displaceable manner in the housing, preferably as a result of positive locking.

8. Induction component according to claim 2, wherein the carrier element (15, 27) is centered in the housing by the housing and/or comprises a centering means for the coil (7).

9. Induction component according to claim 2, wherein the coil (7) is wound from flat wire, the flat side of which extends perpendicular to the coil axis.

10. Induction component according to claim 2, wherein the carrier element (15, 27) comprises a third contact face (25) for connecting to the printed circuit board.

11. Induction component according to claim 2, wherein the carrier element (15, 27) comprises a central ring portion (16, 28) for the centering thereof in relation to the housing and/or in relation to the coil (7).

12. Induction component according to claim 2, wherein the carrier element (15, 27) comprises at least one leg (18, 21) which reaches up to the bottom surface of the housing of the induction component and is there provided with a foot (19).

13. Induction component according to claim 12, wherein the at least one foot (19) comprises a level bottom surface (20), which lies approximately in the plane of the bottom surface (11) of the housing and in which the connection contact (23) emerges.

14. Induction component according to claims 2, wherein the connection realization (24) for connecting the winding ends (8, 9) projects at right angles out of a surface.
